(19) United States
(12) Patent Application Publication
(10) Pub. No.: US 2008/0041534 A1
(43) Pub. Date: Feb. 21, 2008

(54) Suspension Rail

(75) Inventor: Poul Christian Jensen, Odense M (DK)

Correspondence Address: DARBY & DARBY P.C., P.O. BOX 770, Church Street Station, New York, NY, 10008-0770, US

(73) Assignee: FABER A/S, Ryslinge (DK)

(21) Appl. No.: 11/575,814

(22) PCT Filed: Sep. 21, 2005
(86) PCT No.: PCT/DK05/00594

§ 371 Date: Apr. 18, 2007

(30) Foreign Application Priority Data
Sep. 22, 2004 (DK) PA 2004 01438

(51) Int. Cl. E06B 9/323

(52) U.S. Cl. 160/174 R; 160/368.1

(57) ABSTRACT

A suspension rail for Roman blinds, Venetian blinds and the like, comprising a top portion, a rear face and a bottom face connected mutually in the longitudinal direction of the suspension rail, and means for attachment of the suspension rail on a building element, said suspension being configured with a winding mechanism comprising a housing, a turnable drive shaft and a winding drum being rotationally fixed in relation thereto for winding of a string for Roman blinds, Venetian blinds and the like on said winding drum. The invention is characterised in that the interior part of the top part and the rear face, respectively, are provided with respective longitudinally extending protrusions, each of which cooperates with radially protruding, elastic supporting edges on the housing for providing a conveyance of said housing in the longitudinal direction of the suspension rail; and that said radially protruding, elastic supporting edges are configured for cooperating with said longitudinally extending protrusions for providing a snap-connection upon introduction of the housing in the suspension rail.

The present invention relates to a suspension rail for Roman blinds, Venetian blinds and the like, comprising a top part, a rear face and a bottom face mutually connected in the longitudinal direction (L) of the suspension rail, and means for securing the suspension rail on a building element, said suspension rail being configured with a winding mechanism comprising a housing, a turnable drive shaft and a winding drum being rotationally fixed in relation thereto for winding of a string for Roman blinds, Venetian blinds and the like on said winding drum.

Roman blinds usually comprise a number of strings that extend in parallel and run from the top edge to the bottom edge of the Roman blinds. Those strings are each secured to the bottom edge and extend through loops secured to the blind fabric to a winding drum configured at the top edge of the Roman blinds. When the strings are thus wound onto the drum the lower edge is pulled upwards and towards the top edge and the blinds will fold while forming pleats.

JP 11056593 discloses a suspension rail with a through-going drive shaft that connects the individual winding mechanisms to a common tie system configured at an end of the top edge and thus enables that the Roman blinds can be pulled upwards or downwards as needed. A downwardly open U-profile with inwardly facing bottom flanges is configured for displaceable attachment of a winding mechanism in the longitudinal direction of the U-profile. Moreover the suspension rail is provided with a downwardly open cover of the winding drum.

In connection with the mounting of the winding mechanism onto the suspension rail it is a problem that it has to be introduced from an end of the suspension mechanism following which it is displaced in the longitudinal direction to a desired position, following which the blind fabric is mounted. However, it is a problem in connection with the mounting of the winding mechanism that they must be introduced successively from the end of the suspension rail.

This is of course inconvenient and involves an unnecessarily much waste of resources in connection with the production of Roman blinds.

The invention seeks to remedy that problem in that the interior part of the top part and the rear face, respectively, are provided with respective longitudinally extending protrusions, each of which cooperates with a radially protruding elastic supporting edges on the housing for providing a conveyance of said housing in the longitudinal direction of the suspension rail; and that said radially protruding, elastic supporting edges are configured for cooperating with said longitudinally extending protrusions for providing a snap-connection upon introduction by the housing in the suspension rail.

Moreover a suspension rail according to the invention also enables that the blind fabric can be dismounted and replaced without an ensuing need to exchange the entire Roman blinds, since it does not have to be taken into consideration where on the blind fabric the strings are arranged in relation to the winding mechanism. This may be the case eg in a scenario where the Roman blinds are dismounted, eg in connection with exchange or cleaning procedures.

Advantageous embodiments of the invention will appear from the independent claims.

In the following the invention will be explained in further detail with reference to the drawing, wherein

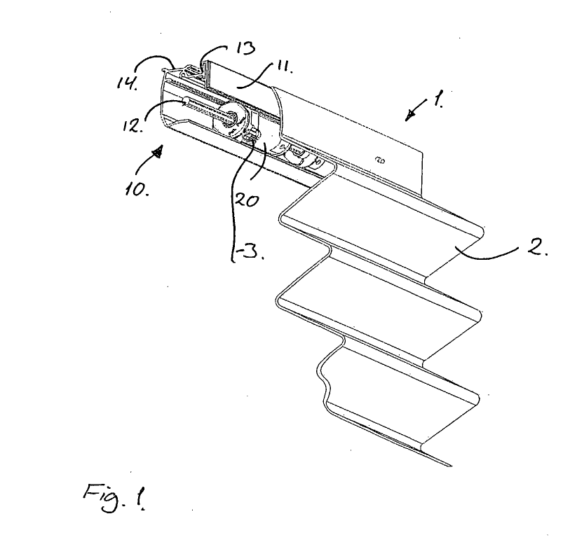

FIG. 1 is a sectional, perspective view of Roman blinds with a suspension rail according to the invention; and

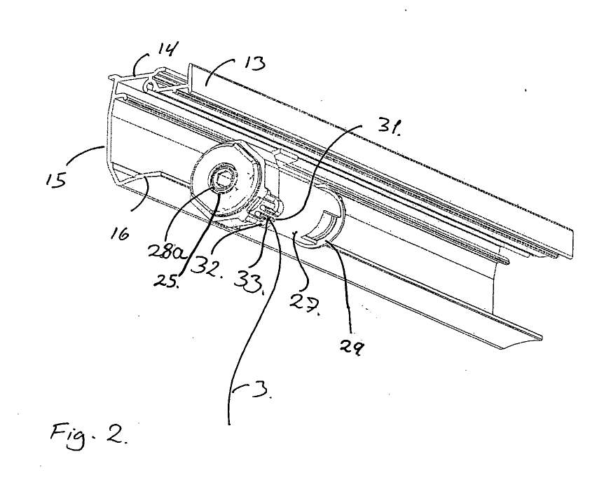

FIG. 2 shows a suspension rail and a winding mechanism from a first angle; and

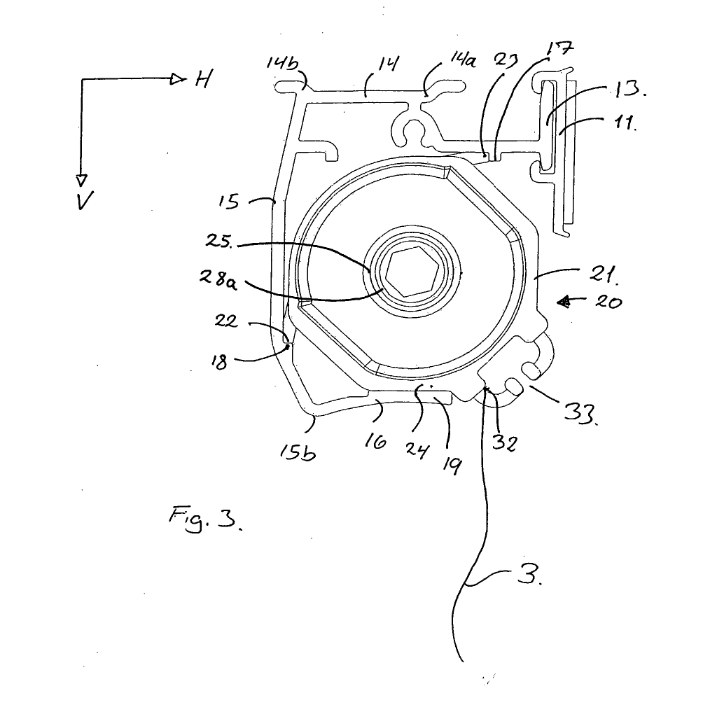

FIG. 3 is a cross-sectional view of a suspension rail with a winding mechanism according to the invention.

Thus, FIG. 1 shows a sectional view of Roman blinds 1 with a suspension rail 10 intended for being secured on a building element such as a wall or a ceiling in connection with eg a door or window opening, or elsewhere where the Roman blinds 1 are to be arranged.

The suspension rail 10 comprises a top part 14 intended for being mounted in abutment on the building element (not shown), and a flange 13 that extends in the longitudinal direction L of the suspension rail and is intended for mounting of a burr-fastener strip 11. The burr-fastener strip 11 has a length that corresponds to the length of suspension rail and is further intended for releasable attachment of blind fabric at an upper edge of the blind fabric. The suspension rail 10 is configured with a winding mechanism 20 which is mounted to be displaceable in the longitudinal direction of the suspension rail 10 interiorly of the suspension rail 10. A portion of the blind fabric 2 which was releasably secured to the burr-fastener strip 11 is “cut” away to show how the winding mechanism is configured interiorly of the suspension rail 10.

FIGS. 2 and 3 show a preferred embodiment of the suspension rail 10 and the winding mechanism 20 in detail. FIG. 2 shows the winding mechanism 20 shown in a non-mounted state on the suspension rail 10.

The winding mechanism 20 comprises an elongate housing 21 with a first and a second radially protruding supporting edge 22, 23 and a carrier face 24, which is configured for providing a support of the housing 21 on the bottom face 16. Moreover, at each end the housing 21 comprises respective bearings 25, 15, at which bearings 25, 26 the winding drum 27 is turnably configured.

The winding drum 27 is configured with a fixed end cap 28 comprising centrally configured journaling means 28a that are configured to cooperate with one of said bearings 25. At the opposite end of the winding drum 27 a second end cap 29 is configured that comprises centrally configured journaling means (not shown) that are configured to cooperate with the bearing 26.

The drive shaft 12 is rotationally connected to the winding drum 27 and is intended for being able to transfer a torque from the drive shaft 12 which may further be connected to an activator string (not shown) by means of which a user operates the Roman blinds. A radially protruding introduction portion 31 most proximate the bearing 25 comprises a supporting face 32 for a string 3 intended for being wound onto the winding drum 27, whereby the blind fabric 2 is either folded or unfolded in response to the user's activation of the activator string (not shown). The protruding introduction portion 31 thus provides an introduction area with an opening/passage 33 for the string 3 via which the string 3 can be released from the opening 33. The opening 33 has an expanse that corresponds at least to the thickness of the string 3.

At an end, the string 3 is secured to the winding drum and conveyed through the introduction area across the supporting face 32, following which the string 3 is conveyed through a straight row of loops that are secured on the rear of the blind fabric 2. In the present context, the rear of the blind fabric 2 will be the side that faces towards the suspension rail 10 and which will moreover face away from the user when the Roman blinds are hung, ie mounted on a building element. The string 3 and the loops are of the kind shown in FIG. 7 of DE 8 200 021 by respective reference numerals 19 and 20.

FIG. 3 shows a cross-sectional view of a preferred embodiment of the suspension rail 10, wherein the winding mechanism 20 is mounted to be displaceable interiorly of the suspension rail 10. A first axis H extends in a first plane in parallel with the top part 14, and perpendicular to the said first axis H a second axis V extends. Mounted on a building element, the axis H will usually be configured horizontally, and the axis V will be configured vertically. At a first longitudinally extending edge 14a the top part 14 is connected to the longitudinally extending strip 13.

At a further longitudinally extending edge 14b the top part 14 is connected to the rear face 15 that extends essentially in a plane in parallel with the axis V. The rear face 15 continues, by a bending 15b, into the bottom face 16 that extends essentially in parallel with the plane H.

Moreover the suspension rail 10 is configured with an interior, longitudinally extending protrusion 17 in the area between the top part 14 and flange 13. Likewise, a longitudinally extending protrusion 18 is formed on the interior part of the rear face 15 in the area at the bending 15b. Moreover, the bottom face 16 is configured to cooperate with a carrier face 24 that extends in a horizontal plane for providing an abutment 19 for the housing 21 in the longitudinal direction of the suspension rail. Said two protrusions 17, 18 are configured for cooperating with radially protruding, elastic supporting edges 22, 23 on the housing 21, where, by introduction of the housing 21 into the suspension rail 10 and essentially perpendicular to the longitudinal direction of the suspension rail, a snap connection is established between supporting edges 22, 23 and the protrusions 17, 18. Moreover a conveyance of said housing 21 is hereby provided in the longitudinal direction L of the suspension rail.

FIG. 3 moreover shows a cross-sectional view of the longitudinally extending flange 13 which is configured for receiving a burr-fastener strip 11 which is displaceable in the longitudinal direction of the suspension rail and configured for securing the blind fabric at the top edge. The burr-fastener strip is advantageously configured with a C-profile which is made to cooperate with said longitudinally extending rail 13 for releasable attachment of the burr-fastener strip.

1. A suspension rail for Roman blinds, Venetian blinds and the like, comprising a top portion, a rear face and a bottom face connected mutually in the longitudinal direction of the suspension rail, and means for attachment of the suspension rail on a building element, said suspension being configured with a winding mechanism comprising a housing, a turnable drive shaft and a winding drum being rotationally fixed in relation thereto for winding of a string for Roman blinds, Venetian blinds and the like on said winding drum, characterised in that the interior part of the top part and the rear face, respectively, are provided with respective longitudinally extending protrusions, each of which cooperates with radially protruding, elastic supporting edges on the housing for providing a conveyance of said housing in the longitudinal direction of the suspension rail; and that said radially protruding, elastic supporting edges are configured for cooperating with said longitudinally extending protrusions for providing a snap-connection upon introduction of the housing in the suspension rail.

2. A suspension rail according to claim 1, characterised in that the bottom face and the rear face provides a cover for said drive shaft and winding drum.

3. A suspension rail according to claim 1, characterised in that said winding drum is configured to be displaceable on the drive shaft in the longitudinal direction of the suspension rail.

4. A suspension rail according to claim 1, characterised in that the bottom face is configured for cooperating with a carrier face on the housing for providing an abutment for the housing in the longitudinal direction of the suspension rail.

5. A suspension rail according to claim 1, characterised in that the winding mechanisms has a radially protruding introduction portion defining, at the one end of the winding drum, an introduction area where the string is conveyed into the winding mechanism.

6. A suspension rail according to claim 1, characterised in that the protruding introduction portion comprises a passage with a supporting face for the string; and an opening via which the string can be released from the passage.

7. A suspension rail according to claim 1, characterised in comprising a longitudinally extending flange, which flange is configured for receiving a burr-fastener strip which is displaceable in the longitudinal direction of the suspension rail and configured for securing the blind fabric.

8. A suspension rail according to claim 7, characterised in that the burr-fastener strip is configured with a C-profile configured for cooperating with said longitudinally extending flange for securing of the burr-fastener strip.
